(19) United States
(12) Patent Application Publication
(10) Pub. No.: US 2011/0011488 A1
(43) Pub. Date: Jan. 20, 2011

(54) LOCKING FUNNEL SYSTEM

(75) Inventor: Vicki Sickler, Emporia, KS (US)

Correspondence Address: Hovey Williams LLP, 10801 Mastin Blvd., Suite 1000, Overland Park, KS, 66210, US

(73) Assignee: Hopkins Manufacturing Corp., Emporia, KS (US)

(21) Appl. No.: 12/503,496

(22) Filed: Jul. 15, 2009

(51) Int. Cl. B67C 11/00

(52) U.S. Cl. 141/1; 141/340; 141/392

(57) ABSTRACT

A funnel including a receiving chamber for receiving a fluid, a spout depending from a bottom portion of the receiving chamber and adapted to be placed at least partially in an opening of a receiving container for transferring the fluid from the receiving chamber to the receiving container, and a flexible support leg extending from the receiving chamber and configured to be at least partially placed in the opening of the receiving container to more securely position the spout in the opening.

### BACKGROUND

1. Field of the Invention

The present invention relates to funnels. More particularly, the invention relates to a funnel with a stabilization arm that secures the funnel in an opening of a receiving container.

2. Background

Funnels are commonly used to transfer fluid from one container to another, such as from a portable, hand-held container to a relatively fixed receiving container or other container. While there have been improvements in funnel design, several deficiencies continue.

For example, funnels can have a stability problem during fluid transfer. Most funnels are designed for use in a variety of receiving containers with openings of varying shapes and sizes. To facilitate use in as many openings as possible, the funnel spout is generally made as small as possible. When a liquid is poured into the funnel, the force from the liquid can shift the funnel and can even dislodge the funnel spout from the receiving container opening. A small spout, while providing increased adaptability to mate with varying-sized openings, serves only to amplify the stability problem. Large portable containers exacerbate this problem because they are often too heavy to be effectively wielded with a single hand while holding the funnel with the other.

There have been various attempted solutions to these problems. For example, threaded funnel spouts that mate with a matching thread on the receiving container opening have been developed. While these funnels are very secure, they can only be used with containers having an opening the exact same size as the funnel spout and with exactly matching threads.

Non-threaded funnel designs have also been tried, such as quarter-turn or snap-on funnels. These are also more stable than traditional funnels, but also are not universal because they must be designed for a specific size and type of opening.

Various clamping mechanisms and other mechanical structures have also been tried. Clamping mechanisms may work, but they are often complex, expensive, and require significant patience to properly attach to the receiving container. Mechanical “legs” have been adapted to some funnel designs and, while they function well on a smooth, level surface, they are difficult to use on vehicles because of the irregular surfaces encountered. Funnels with adjustable legs can help stability on uneven surfaces, but adjustable legs can add significant cost to a relatively simple, and inexpensive device.

Most of these solutions also create another problem: the funnels do not pack tightly for shipment because the various stabilization mechanisms prevent the funnels from nesting within each other. The extra space required for shipping from the manufacturer to the ultimate buyer can significantly increase the price of the funnels. Clamping mechanisms, in particular, suffer from this shortcoming.

Accordingly, there is a need for an improved funnel that overcomes the limitations of the prior art. More particularly, there is a need for a funnel which can be used with receiving containers having different sized openings, which is securely held in the opening without additional support from the user, which is easy to use, and which can be packed as tight as possible for shipment to reduce transportation costs.

### SUMMARY

The present invention solves at least some of the above-described problems and provides a distinct advance in the art of funnels. More particularly, the present invention provides a funnel that provides stability within receiving container openings of different sizes and allows the device to be nested tightly to minimize transportation costs.

One embodiment of the present invention is a funnel comprising a receiving chamber, a spout and a flexible support leg. The spout and support leg depend from the receiving chamber.

The receiving chamber is designed to receive a fluid from a portable container and direct the fluid to the receiving container. The receiving chamber has generally upright sidewalls, an open top and a bowl-shaped bottom portion with an opening. The sidewalls of the receiving chamber are predominantly vertical to reduce the force of the liquid striking perpendicularly to the surface of the receiving chamber and thereby dislodging the funnel spout from the opening of the opening of the container. The receiving chamber may also have a generally planar section to further enhance this effect.

The spout is designed to fit within the opening of the receiving container and allow fluid passage from the receiving chamber into the receiving container. The spout is hollow with a generally cylindrical shape and two generally circular openings at opposing ends. The first opening aligns with the opening in the bottom portion of the receiving chamber and the second opening is at the distal end of the spout. The first opening of the spout is of the same or larger diameter than the second opening of the spout.

The spout may be short to allow the receiving chamber to rest on the opening of the container without the spout resting on a structure internal to the container. Additionally, the diameter of the spout should be as wide as possible to increase the flow of the liquid from the receiving chamber, through the spout, to the container. However, the spout must be reasonably narrow to allow mating with as many container openings of varying sizes as possible.

The support leg is designed to secure the funnel within the opening of the receiving container. The support leg depends from the outside of the receiving chamber sidewall and extends in a direction generally parallel to the spout. The support leg extends below the receiving chamber to the generally same extent as the spout, but the support leg may be longer or shorter depending on the diameter of the bottom portion of the receiving chamber or the desired engagement point of the support leg in the receiving container opening. The cross-section of the support leg may be rectangular, U-shaped, or other shape depending on the material and the force desired to stabilize the funnel within the opening of the receiving container.

The support leg has other features which add further stability. For example, the support leg is generally L-shaped so that a portion of the leg more effectively engages the neck of the receiving container opening. Additionally, support structures may be attached to the distal portion of the L-shaped support leg which also fit within the receiving container opening to provide additional lateral stability. The support leg and the spout exert pressure along a first axis and the two support structures exert force along a second axis which is predominantly perpendicular from the first axis, depending on the size of the opening.

The funnel can be made from plastic, nylon, metal or any generally sturdy material. Additionally the individual components, and particularly the support leg, may be made from different materials, as necessary. For example, the receiving chamber and spout may be made from metal and the support leg may be made from plastic.

In use, the support leg fits within the opening of the receiving container to provide additional stability to the funnel. The stabilization leg is placed in the receiving container opening, the funnel is moved such that the support leg bends against the receiving chamber of the funnel, then the spout portion of the funnel is also placed in the opening. With both portions of the funnel within the opening simultaneously the support leg exerts pressure latterly within the container opening. The lateral pressure forces the spout to the edge of the container opening opposite to the stabilization arm. Thus, lateral pressure is placed on the opening by both the spout and the support leg, securing the apparatus in place.

This summary is provided to introduce a selection of concepts in a simplified form that are further described below in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a funnel constructed in accordance with an embodiment of the invention.

FIG. 2 is a perspective view of the funnel inserted in a receiving container opening.

FIG. 3 is a perspective view of the funnel from generally the spout-side of the funnel.

FIG. 4 is a front elevational view of the funnel.

FIG. 5 is a perspective view showing the funnel being positioned relative to a receiving container before insertion therein.

FIG. 6 is a perspective view showing insertion of the distal end of the flexible support leg in the opening of the receiving container.

FIG. 7 is a perspective view showing further insertion of the distal end of the flexible support leg in the opening of the receiving container and movement of the the spout toward the opening of the receiving container.

FIG. 8 is a perspective view showing the spout oriented over the opening of the receiving container.

FIG. 9 is a perspective view showing the spout and the distal end of the support leg fully inserted into the opening of the receiving container.

FIG. 10 is a bottom view of the funnel installed in the receiving container.

FIG. 11 is a vertical sectional view of three funnels nested together.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

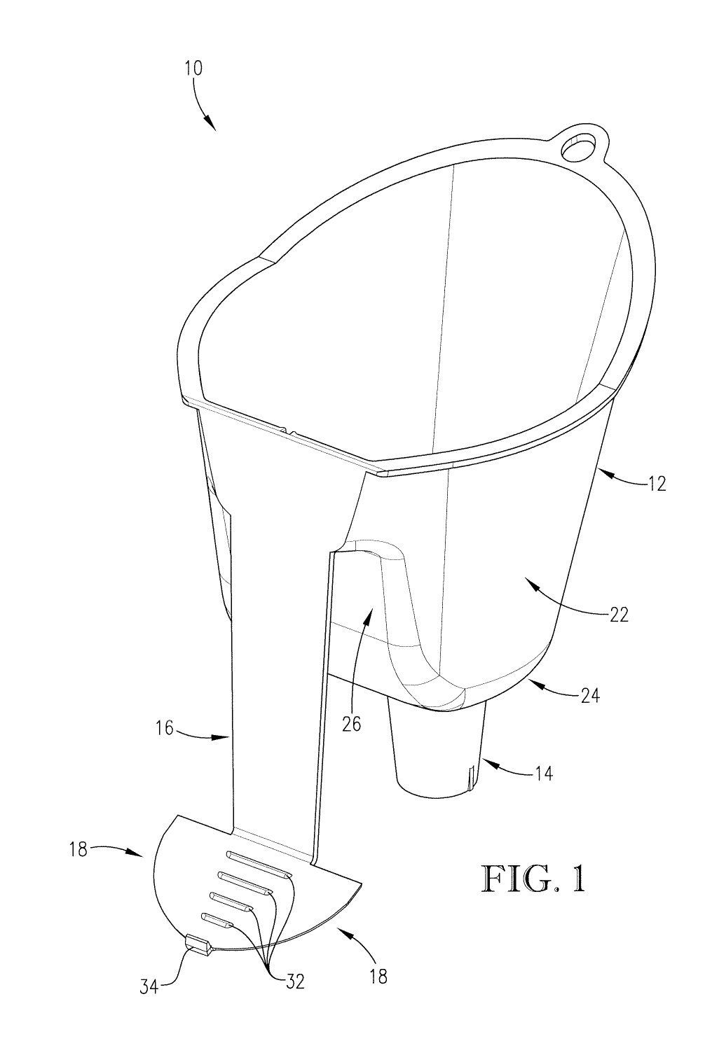

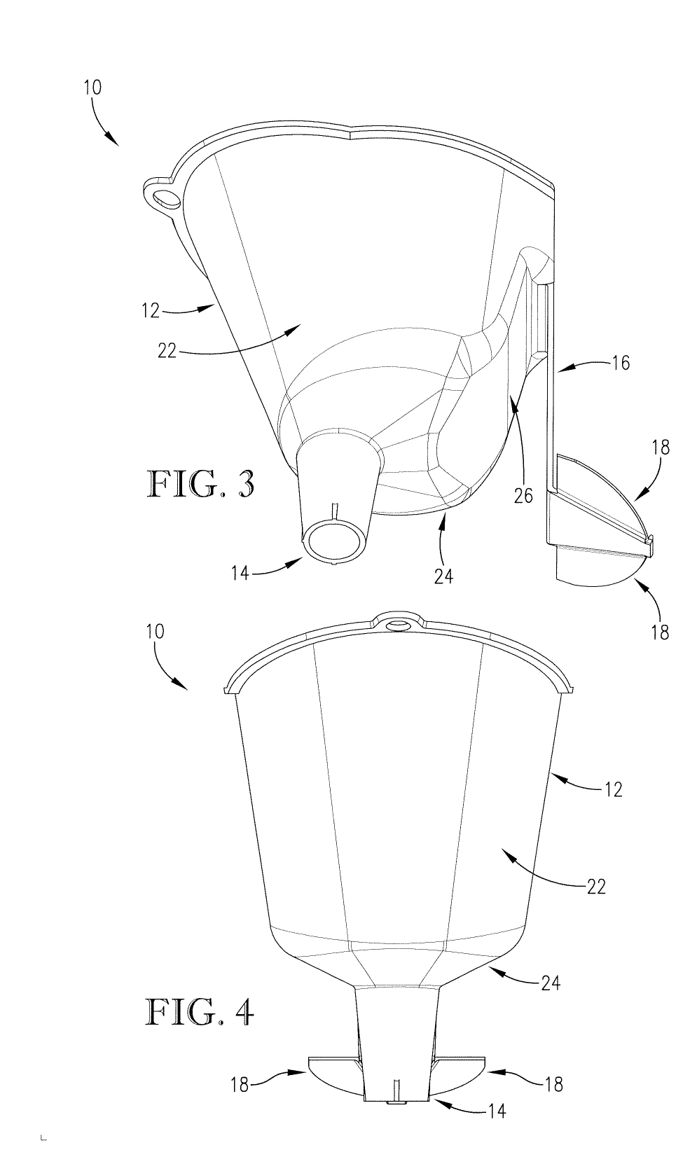

Turning now to the drawing figures, and particularly FIGS. 1-4, a funnel 10 constructed in accordance with an embodiment of the invention is illustrated. The funnel 10 broadly includes a receiving chamber 12, a spout 14 and a flexible support leg 16.

The receiving chamber 12 receives fluid to be passed through the funnel 10 to a receiving container 28 such as a fuel tank, or any other fluid-holding container. The receiving chamber 12 has generally upright sidewalls 22, an open top, and a generally bowl shaped bottom portion 24 to accommodate a volume of fluid therein. The receiving chamber 12 may be constructed of plastic, metal or any suitable material depending on the intended application. For example, plastic may be desirable because it is generally low-cost and lightweight. However, some solvents may not be compatible with plastic and thus, a metal receiving chamber may be preferable. In some embodiments, the sidewalls 22 of the receiving chamber 12 may incorporate one or more generally planar portions 26 to decrease the lateral force that can dislodge a traditional funnel from the receiving container opening 20. The sidewalls 22 of the receiving chamber 12 can be of any suitable thickness depending on the material, the size of the receiving chamber 12, the weight of the fluid to be transferred and the durability required.

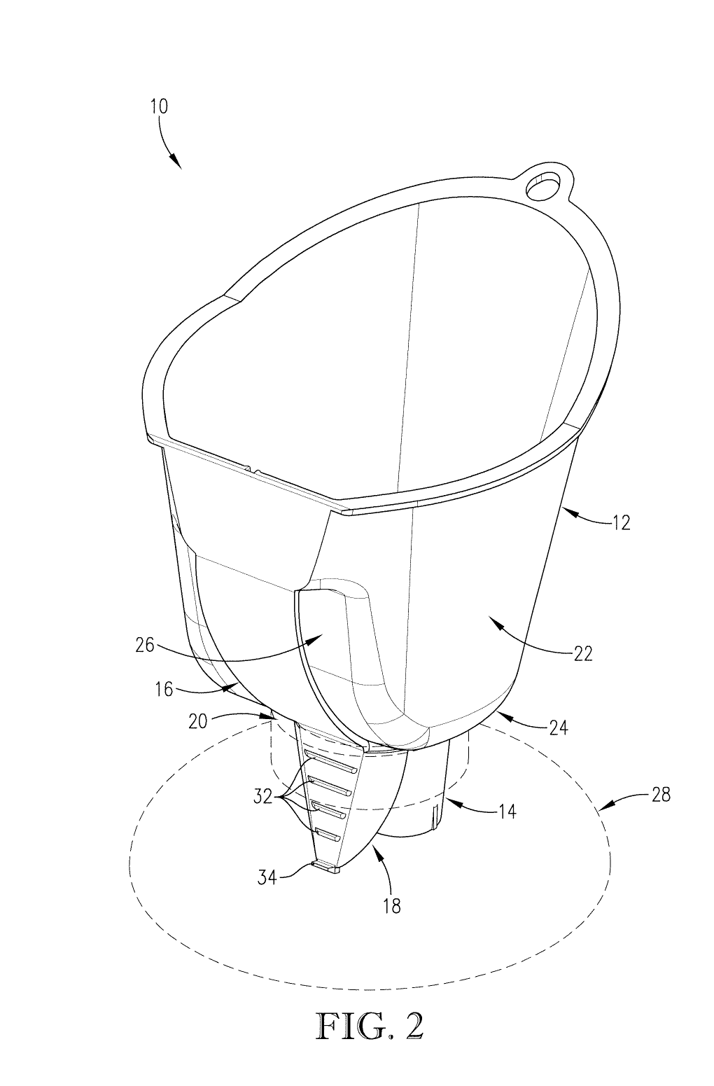

The spout 14 depends from the bottom portion 24 of the receiving chamber 12 and directs the fluid from the receiving chamber 12 into the receiving container opening 20. The spout 14 fits within the receiving container opening 20, as shown in FIG. 2. The spout 14 is hollow with a generally cylindrical shape and two generally circular openings at opposing ends. The first opening aligns with the opening at the bottom portion 24 of the receiving chamber 12 and the second opening is at the distal end of the spout. The diameter of the spot is generally as wide as possible to allow the fluid to flow from the receiving chamber 12 through the spout 14 into the receiving container as quickly as possible. The diameter of the first end of the spout is generally the same as or larger than the diameter of the second end of the spout. The spout 14 must also be reasonably narrow so that it may fit within as many receiving container openings as possible. The spout 14 should be sufficiently long to allow for stabilization of the funnel 10 within the neck of the receiving container opening 20. However, a spout 14 that is too long may prevent proper stabilization by resting on internal features of the receiving container. The spout 14 may be made from any suitable material in any thickness, but is generally made from the same material and in the same thickness as the receiving chamber 12.

The flexible support leg 16 depends from the outside of the receiving chamber 12 in generally the same direction as the spout 14 and, along with the spout 14, secures the funnel system 10 in the receiving container opening 20, as shown in FIG. 2. The flexible support leg 16 extends below the spout 14 generally to the same extent as the spout 14, but the flexible support leg 16 may be longer or shorter depending on the size of the receiving chamber 12 or the desired engagement point of the flexible support leg 16 in the receiving container opening 20. The flexible support leg 16 may have a cross-section that is rectangular, U-shaped, elliptical or other shape, depending on the stabilization force desired. The flexible support leg 16 may be made from plastic, nylon, metal or other material that can bend and return to its original shape. The flexible support leg 16 may be made from the same material as the receiving chamber 12 and spout 14, or it can be made from a different material and secured to receiving chamber 12. The flexible support leg 16 may also contain notches on the lateral or medial sides to facilitate bending.

In a preferred embodiment, the flexible support leg 16 is generally L-shaped with a rectangular cross-section. In this embodiment, the distal portion of the flexible support leg 16 additionally includes stabilization structures 18 extending laterally from the flexible support leg 16. The flexible support leg 16 also includes gripping structures 19 The stabilization structures 18 can vary in size and shape depending on the size of the desired receiving container opening 20, and the desired stabilization effect. The stabilization structures 18 may be the same thickness as the flexible support leg 16 or they may differ. In the preferred embodiment above, the stabilization structures 18 are thinner than the flexible support leg 16. The stabilization structures 18 may be the same material as the flexible support leg 16 or they may be a different material.

Additionally, in this embodiment the flexible support leg 16 includes flexible support leg gripping structures 32 and a catch tab 34 to provide securing force within the receiving container opening 20. The number of such flexible support gripping mechanisms 32 may be as few as one or there may be more, depending on the length of the flexible support leg 16 and the desired gripping effect. The flexible support leg gripping mechanisms 32 may be made from the same material as the flexible support leg 16 or different material may be used. The flexible support leg gripping mechanisms 32 may be molded into the flexible support leg 16 or the flexible support leg gripping mechanisms 32 may be attached or adhered to the flexible support leg 16 in some way. Preferably, the flexible support leg gripping mechanisms 32 are a plurality of ridges oriented perpendicular to the major axis of the flexible support leg 16 such that, when inserted into a container opening 20, the flexible support leg gripping mechanisms 32 contact the receiving container 12 to enhance the stabilization effect of the funnel 10.

The catch tab 34 extends laterally from and generally perpendicular to the distal tip of the flexible support leg 16. The catch tab 34 may be made from the same material as the flexible support leg 16 or different material may be used. The catch tab 34 may be molded into the flexible support leg 16 or the catch tab 34 may be attached or adhered to the flexible support leg 16 in some way. Preferably, the catch tab 34 is oriented perpendicular to the major axis of the flexible support leg 16 such that, when inserted into a container opening 20, the catch tab 34 contacts the inside of receiving container 12 to enhance the stabilization effect of the funnel 10.

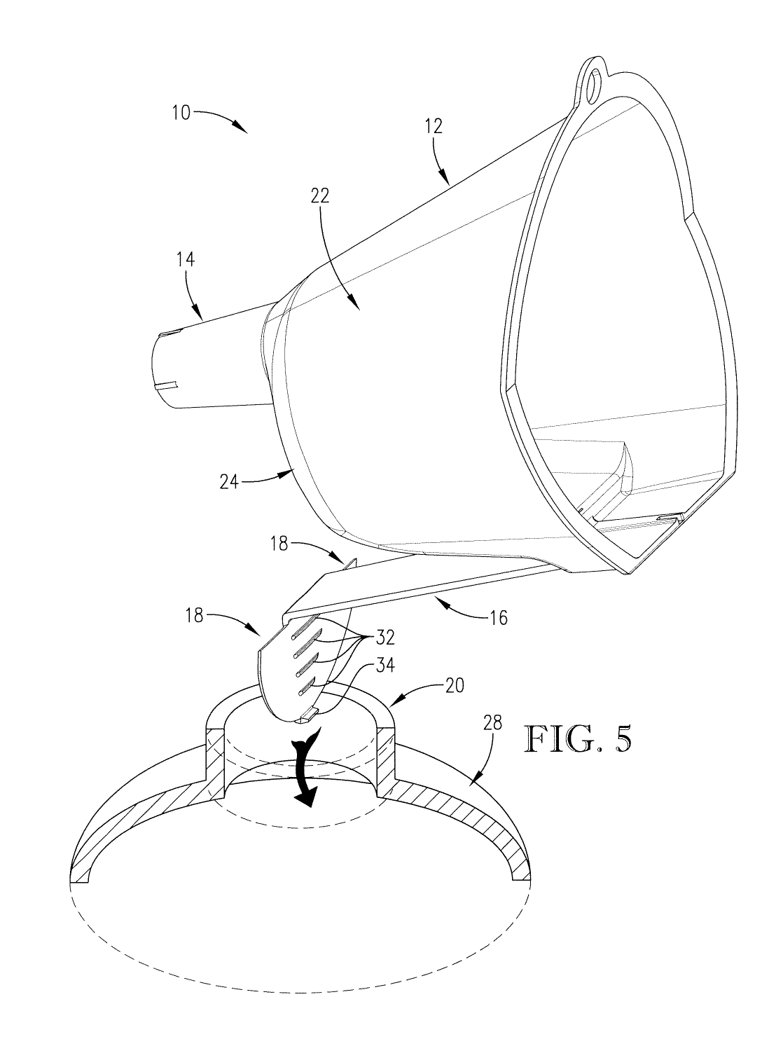

FIG. 5 shows an embodiment of the funnel 10 being positioned relative to the receiving container opening 20 before insertion of the flexible support 16 leg into the receiving container opening 20. The funnel 10 is oriented such that the distal portion of the flexible support leg 16 has a generally vertical orientation. The funnel 10 is the lowered toward the receiving container opening 20.

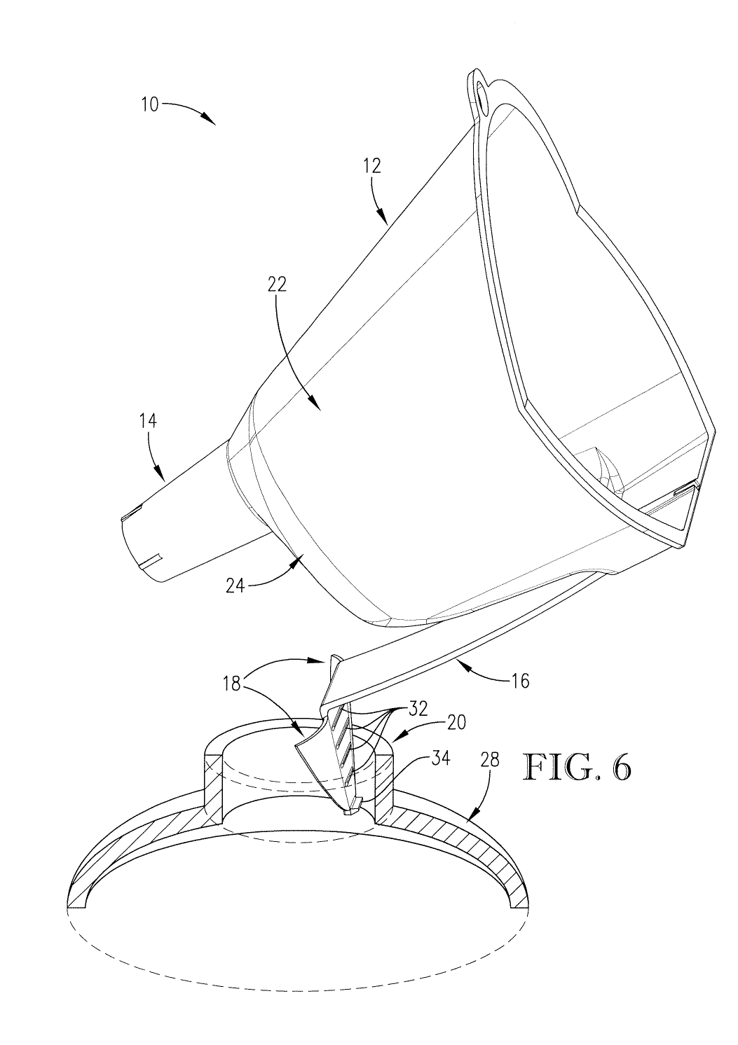

FIG. 6. shows the insertion of the distal end of the flexible support leg 16 into the receiving container opening 20. The stabilization structures 18 bend to conform to the inner contour of the receiving container opening 20. The funnel 10 is lowered and the spout 14 is moved toward the receiving container opening 20.

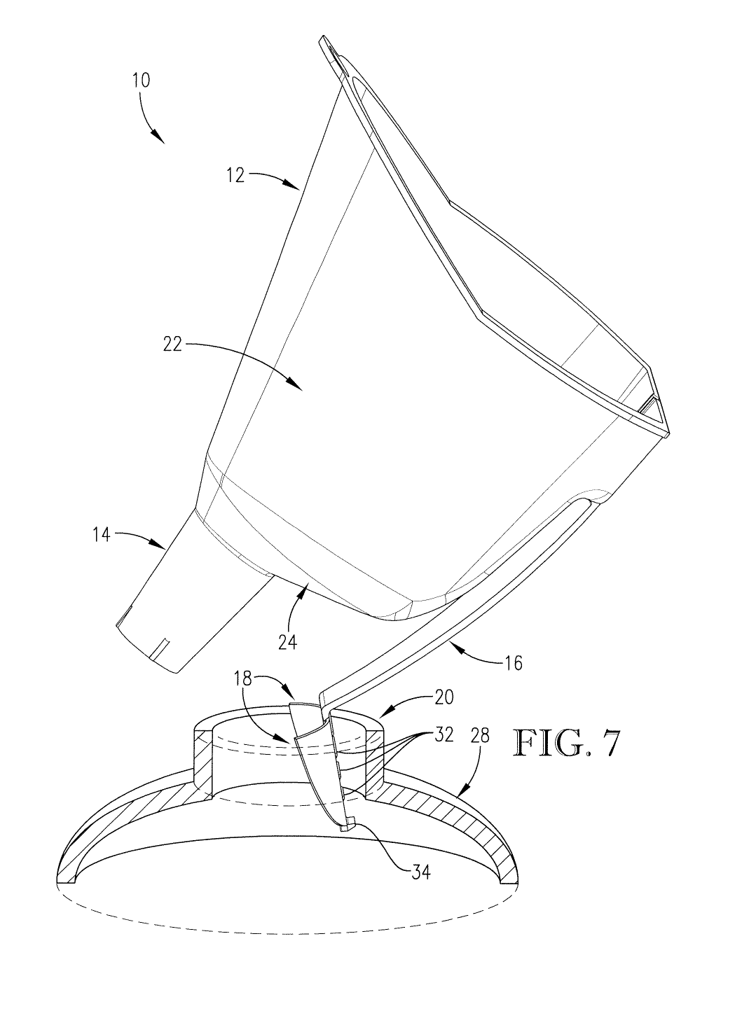

FIG. 7. shows further insertion of the distal end of the flexible support leg 16 in the receiving container opening 20. The spout 14 is moved closer to the receiving container opening 20. The stabilization structures 18 are fully within the receiving container opening 20 and bent to conform with the inner contour of the receiving container opening 20.

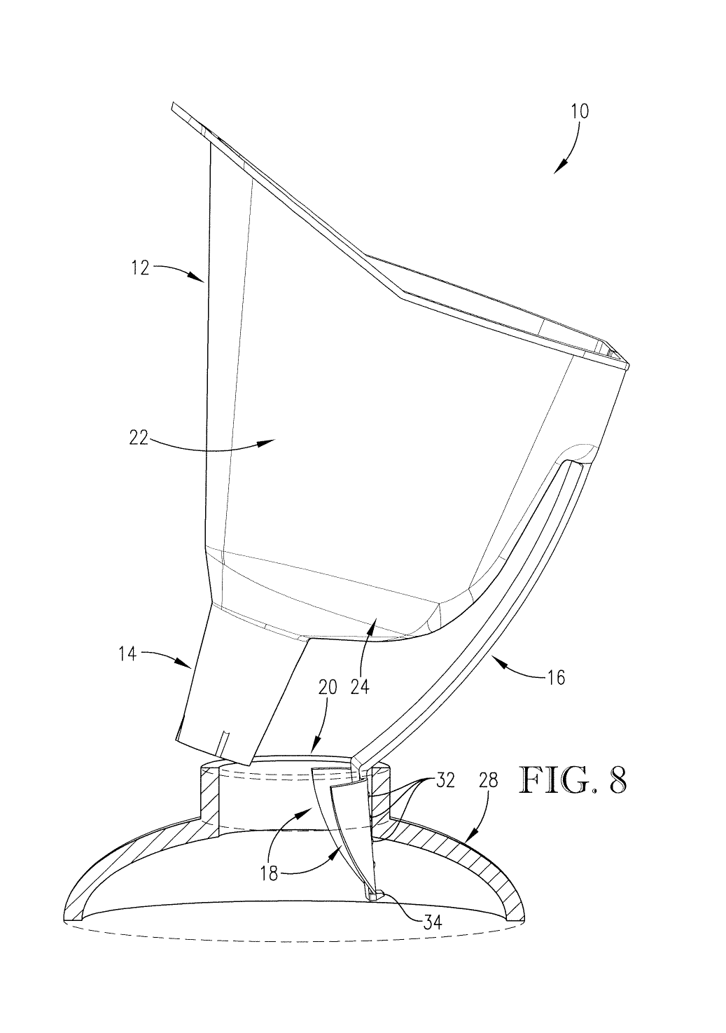

FIG. 8. shows the spout 14 oriented over the receiving container opening 20. The stabilization structures 18 are fully within the receiving container opening and the flexible support leg 16 is bent.

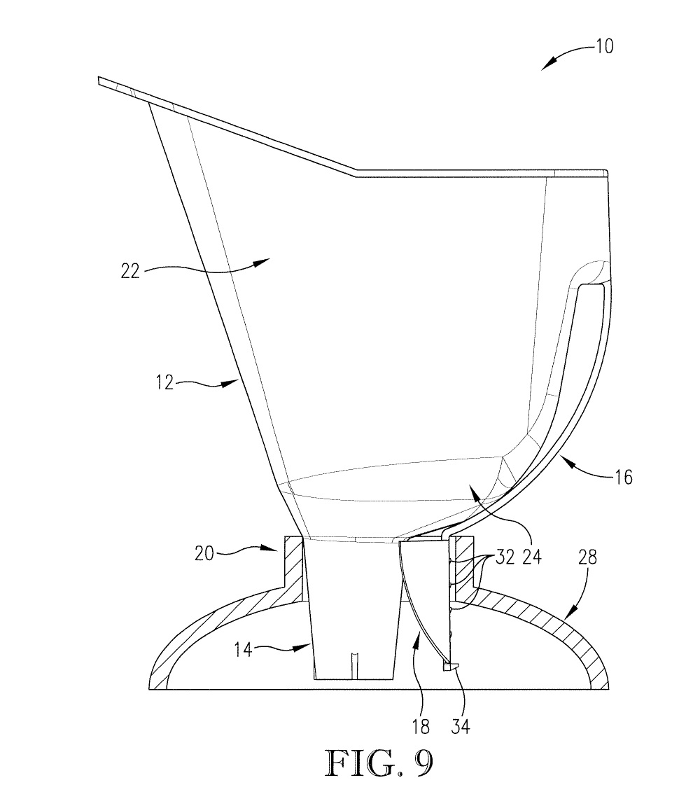

FIG. 9. shows the spout 14 fully inserted into the opening of the receiving container 20. The flexible support leg 16 is bent against outer surface of the receiving container 12 and the stabilization structures 18 are bent to conform with the inner contour of the receiving container opening 20. In this configuration, the flexible support leg 16 applies force against the inside of the receiving container opening 20 pushing the spout 14 against the opposite side of the receiving container opening 20.

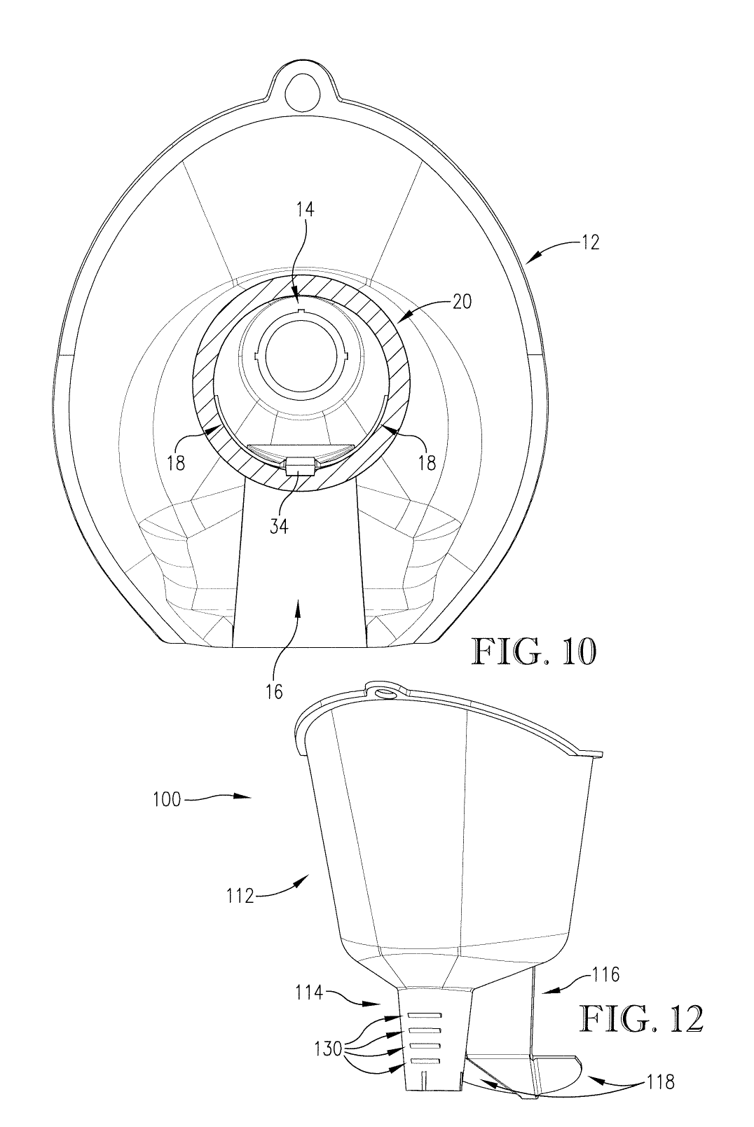

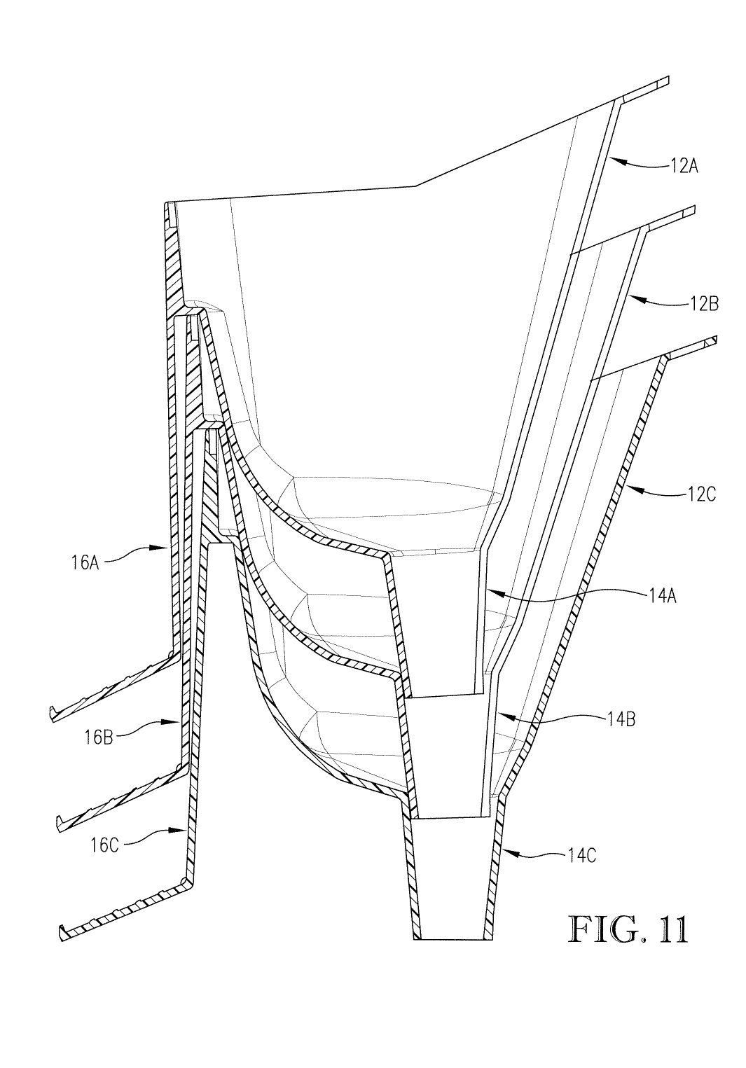

FIG. 10 shows the funnel fully inserted in the receiving container opening 20. The flexible support leg 16 fits within and applies force to the inside of the receiving container opening 20 along an axis defined by the flexible support leg 16 and the spout 14. As the flexible support leg 18 applies force to the inside of the receiving container opening 20, the spout is forced against the opposite side of the receiving container opening 20. Thus, pressure is applied to opposite sides of the inside of the receiving container opening 20. Additionally, the stabilization structures 18 apply force to the inside of the receiving container opening 20 along an axis largely perpendicular to the axis defined by the support leg 16 and the spout 14, depending on the size of the receiving container opening 20 and the size of the stabilization structures 18.

FIG. 11 shows three funnels constructed in accordance with an embodiment of the invention nested for shipment or storage. As shown, a first receiving chamber 12A is operable to fit at least partially within a second receiving chamber 12B. The second receiving chamber 12B is also operable to fit at least partially within a third receiving chamber 12C. Correspondingly, a first spout 14A is operable to fit at least partially within a second spout 14B. The second spout 14B is also operable to fit at least partially within a third spout 14C. Additionally, a first flexible support leg 16A is operable to at least partially overlap a second flexible support leg 16B. The second flexible support leg 16B is also operable to at least partially overlap a third flexible support leg 16C.

FIG. 12 illustrates a funnel 100 constructed in accordance with an alternate embodiment of the invention. The funnel 100 is substantially identical to the funnel 10 shown in FIGS. 1-11 except that it includes spout gripping mechanisms 130 on the spout 114. The receiving chamber 112, the spout 114, the flexible support leg 116 and the stabilization structures 118 of the funnel 100 of FIG. 12 correspond generally to the receiving chamber 12, the spout 14, the flexible support leg 16 and the stabilization structures 18 of the funnel 10 shown in FIGS. 1-11. The gripping mechanisms 130 may be ridges or grooves. The number of such gripping mechanisms may be as few as one or there may be more, depending on the length spout 114 and the desired gripping effect. The spout gripping mechanisms 130 may be made from the same material as the spout 114 or different material may be used. The spout gripping mechanisms 130 may be molded into the spout 114 or the spout gripping mechanisms 130 may be attached or adhered to the spout 114 in some way. The spout gripping mechanisms 130 may extend circumferentially around the entire spout 114, or they may extend over only a portion of the spout 114. Preferably, the spout gripping mechanisms 130 are a plurality of ridges oriented perpendicular to the major axis of the spout 114 such that, when inserted into a container opening 120, the spout gripping mechanisms 130 contact the receiving container 120 to enhance the stabilization effect of the funnel 100.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A funnel comprising:
a receiving chamber for receiving a fluid;
a spout depending from a bottom portion of the receiving chamber and adapted to be placed at least partially in an opening of a receiving container; and
a flexible support leg extending from the receiving chamber and configured to be at least partially placed in the opening of the receiving container to more securely position the spout in the opening.

2. The funnel of claim 1 wherein the spout comprises:
a first generally circular open end having a first diameter, and
a second generally circular open end opposite the first open end having a second diameter, the first diameter being less than or equal to the second diameter, and the second end attached to the bottom portion of the receiving container.

3. The funnel of claim 2 wherein the receiving chamber comprises:
a bowl-shaped sidewall having a bottom portion, an upstanding wall and an open top, the bottom portion having an opening in fluid communication with, and of the same shape and diameter as, the second circular opening in the spout.

4. The funnel of claim 3 wherein the sidewall includes a generally planar surface.

5. The funnel of claim 1 wherein the flexible support leg is generally L-shaped.

6. The funnel of claim 5 further comprising a stabilization structure fixedly attached to a distal end of the flexible support leg.

7. The funnel of claim 6 wherein the stabilization structure is rectangular-shaped.

8. The funnel of claim 6 wherein the stabilization structure is the shape of a circle quadrant.

9. The funnel of claim 6 wherein the stabilization structure has a rectangular cross-section.

10. The funnel of claim 1 wherein the spout is less than one and a half inches long.

11. The funnel of claim 1 wherein the first diameter of the spout is at least one-half inch.

12. The funnel of claim 1 wherein the support leg provides clamping force to hold the funnel in the opening.

13. The funnel of claim 1 further comprising a spout gripping mechanism structure fixedly attached to the spout.

14. The funnel of claim 1 further comprising a flexible support leg gripping structure fixedly attached to the flexible support leg.

15. The funnel of claim 1 further comprising a catch tab fixedly attached to the distal portion of the flexible support leg.

16. In combination:
a first funnel comprising:
a receiving chamber for receiving a fluid;
a spout depending from a bottom portion of the receiving chamber and adapted to be placed at least partially in an opening of a receiving container; and
a flexible support leg extending from the receiving chamber and configured to be at least partially placed in the opening of the receiving container to more securely position the spout in the opening;
a second funnel comprising:
a receiving chamber for receiving a fluid;
a spout depending from a bottom portion of the receiving chamber and adapted to be placed at least partially in an opening of a receiving container; and
a flexible support leg extending from the receiving chamber and configured to be at least partially placed in the opening of the receiving container to more securely position the spout in the opening;
where the first funnel is capable of nesting within the second funnel wherein
the spout of the first funnel being placed at least partially within the spout of the second funnel,
the receiving chamber of the first funnel being placed at least partially within the receiving chamber of the second funnel,
the support leg of the first funnel being placed at least partially over the support leg of the second funnel.

17. The funnel of claim 16 wherein the support leg has a rectangular cross-section.

18. The funnel of claim 16 wherein the support leg has a U-shaped cross section.

19. The funnel of claim 16 wherein the support leg provides clamping force to hold the funnel in the opening.

20. The funnel of claim 14 further comprising a spout gripping mechanism fixedly attached to the spout.

21. A method of placing a funnel in a container opening where the funnel comprises a receiving chamber, spout, and an attached support leg, the method comprising:
placing the support leg of the funnel in the container opening;
moving the funnel to bend the support leg against the receiving chamber of the funnel and position the spout over the container opening;
placing the spout within the container opening; and
lowering the funnel into the container opening until the spout is substantially contained within the container opening.
